(19) United States
(12) Patent Application Publication
(10) Pub. No.: US 2013/0272667 A1
(43) Pub. Date: Oct. 17, 2013

(54) SENSOR CABLE FOR LONG DOWNHOLE

(71) Applicants: Yoshio Hashimoto, Greer, SC (US); Joe Cignarale, Greer, SC (US)

(72) Inventors: Yoshio Hashimoto, Greer, SC (US); Joe Cignarale, Greer, SC (US)

(73) Assignee: AFL TELECOMMUNICATIONS LLC, Duncan, SC (US)

(21) Appl. No.: 13/511,569

(22) PCT Filed: Apr. 12, 2012
(86) PCT No.: PCT/US12/33195

§ 371 Date: May 23, 2012

(51) Int. Cl. G02B 6/44

(52) U.S. Cl. 385/103

(57) ABSTRACT

A cable includes an armored layer comprising a plurality of annular wires and at least one of the plurality of annular wires is composed of a metallic tube and a strengthening member.

### CROSS-REFERENCE TO RELATED APPLICATIONS

This application is based upon and claims the benefit of priority from United States Provisional Application No. 61/474,425, filed Apr. 12, 2011, the disclosure of which is incorporated herein in their entirety by reference.

### BACKGROUND OF THE INVENTION

1. Field of the Invention

The invention is related to a logging-type cable, i.e., a cable that goes in and out of the well repeatedly. More particularly, it is related to the logging-type cable which is suitable for sensing in the down hole with higher temperature and deeper depth.

2. Background

In the oil and gas downhole field, optical fibers are used for sensing the distribution of temperature. A cable containing an optical fiber covered by Stainless Steel Tube (SST) is well known as a Distributed Temperature Sensor Cable (DTS cable). In this cable structure, the optical fiber is protected by the SST from water pressure at the deep sea.

Typically, the SST described above is placed at the center of the cable and plural wires surround it. The purposes of the surrounding wires are 1) to protect the optical fibers disposed inside the SST from the external impact or any damage (armoring) and 2) to protect the optical fibers inside the SST from the tension caused during the installation.

In recent years, BOTDR (or BOTDA) analyzing system for sensing the temperature and pressure distribution at the same time is under the development. The cable used for this system is called Distributed Pressure and Temperature Sensor (DPTS) cable. An example of the cable structure has been described in US 2011/022505. In this invention, an exposed optical fiber which is mainly for pressure sensing is placed at the center of the cable. The pressure sensing optical fiber is surrounded by several wires and an SST containing an optical fiber which is for temperature sensing in the same way as DTS.

With such current key technology such as DTS or DPTS, one of the demands for the cable is to provide ability to obtain data in a deeper downhole. In order to satisfy this demand, there will be several issues to be remedied.

First, installation into the longer vertical downhole will induce lager pulling power onto the cable because of its own weight. The higher tension onto the cable will cause the higher strain of the cable components around the top of the down hole.

Second, at the bottom of the deeper downhole, it is expected that the cable is exposed to a higher temperature. The higher temperature will necessarily cause higher strain onto the cable components because of its thermal expansion. These higher strain remain during the operation and it can affect the cable life time. This invention discloses how to restrain the cable strain caused by both high tension and high temperature. This disclosure illustrates new DPTS cable designs which are suitable for sensing in higher temperature and deeper depth of down hole, but these inventions are not limited these specific application.

### BRIEF SUMMARY OF THE INVENTION

Exemplary implementations of the present invention address at least the issues described above and the objects described below. Also, the present invention is not required to address the issues described above or objects described below, and an exemplary implementation of the present invention may not address the issues listed above or objects described below.

An object of the invention is to provide a structure that allows for an optical fiber to be used in the long oil and gas downhole field.

Another object of the invention is to provide a structure where the optical fiber is used to sense attributes of the harsh environment such as high temperature.

Another object of the invention is to provide a structure that not only sufficiently protects the optical sensor but also have lighter weight so that strains of the cable can be reduced. In doing so, the cable can be used in a deeper oil and gas downhole field.

A first embodiment includes an armored layer comprising a plurality of annular wires and at least one of the plurality of annular wires is made up of a metallic tube and a strengthening member.

Another embodiment of the cable in the first embodiment may have the metallic tube composed of stainless steel.

Another embodiment of the cable in the first embodiment may have an optical fiber is arranged inside one of said annular wires of said armored layer.

Another embodiment of the cable in the first embodiment may have an optical fiber surrounded by a wire armor is surrounded by said armored layer.

Another embodiment of the cable in the first embodiment may have the wire armor composed of a plurality of galvanized improved plow wires.

Another embodiment of the cable in the first embodiment may have the armored layer is surrounded by a plurality of metallic wire.

Another embodiment of the cable in the first embodiment may have the strengthening member being an aramid yarn.

Another embodiment of the cable in the first embodiment may have the strengthening member being a PBO yarn.

Another embodiment of the cable in the first embodiment may have the strengthening member being a Polyacrylonitarile carbon fiber.

A second embodiment includes a center annular wire, an armored layer comprising a plurality of annular wires where the center annular wire and the plurality of annular wires are made up of a metallic tube and a strengthening member.

Another embodiment of the cable in the second embodiment may have the metallic tube made up of stainless steel.

Another embodiment of the cable in the second embodiment may have an optical fiber formed substantially concentric circle along with said armored layer.

Another embodiment of the cable in the second embodiment may have an optical fiber arranged inside of said annular wire.

Another embodiment of the cable in the second embodiment may have the armored layer surrounded by plurality of metallic wire.

Another embodiment of the cable in the second embodiment may have the strengthening member being an aramid yarn.

Another embodiment of the cable in the second embodiment may have the strengthening member being a PBO yarn.

Another embodiment of the cable in the second embodiment may have the strengthening member being a Polyacrylonitarile carbon fiber.

### BRIEF DESCRIPTION OF THE DRAWINGS

The above and other objects, features and advantages of the invention will become more apparent by describing in detail exemplary embodiments thereof with reference to the attached drawings in which:

FIG. 1 shows a cross-sectional view of an example of conventional DPTS cables.

FIG. 2 shows a cross-sectional view of another example of conventional DPTS cables.

FIG. 3A shows an isometric view of a metallic tube with strengthening members enclosed inside.

FIG. 3B shows a cross-sectional view of a metallic tube with strengthening members enclosed inside.

FIG. 4 shows a cross-sectional view of a first embodiment of a sensor cable for long downhole.

FIG. 5 shows a cross-sectional view of a second embodiment of a sensor cable for long downhole.

### DETAILED DESCRIPTION OF EXEMPLARY EMBODIMENTS OF THE INVENTION

Exemplary embodiments of the invention will now be described below by reference to the attached Figures. The described exemplary embodiments are intended to assist the understanding of the invention, and are not intended to limit the scope of the invention in any way.

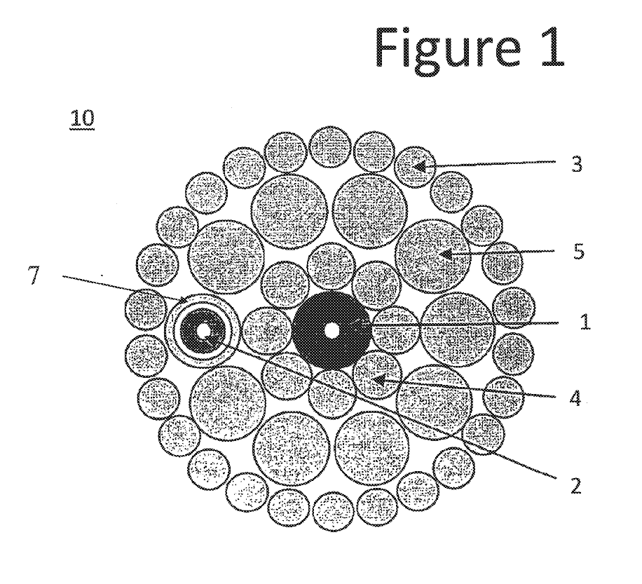

FIG. 1 shows one example of a conventional cable 10. A pressure fiber 1 is arranged at the center of the cable and it is surrounded by galvanized improved plow (GIP) wires 4 as an armor. In the current example, eight (8) GIPs having a range of 0.75˜0.80 mm in diameter are used as a first layer surrounding the pressure fiber 1. A second layer 5 including a temperature measurement optical fiber 2 disposed inside the SST surrounds the first layer. The SST 7 shown in FIG. 1 has no strengthening member inside the metallic tube. In the current embodiment, nine (9) GIPs having a range of 1.15˜1.20 mm in diameter are used as the second layer. Lastly, the pressure fiber and two inner layers 4 and 5 are surrounded by twenty-four (24) GIPs 3 having a range of 0.60˜0.65 mm in diameter.

The cable shown in FIG. 1 is 171.5 kg/km in its weight per length. When the cable is installed into 5 km of a downhole, 0.196% of cable strain will be applied because of its own weight. It is assumed that the temperature of the bottom of the downhole will reach up to 180° C. which will cause 0.184% of additional cable strain.

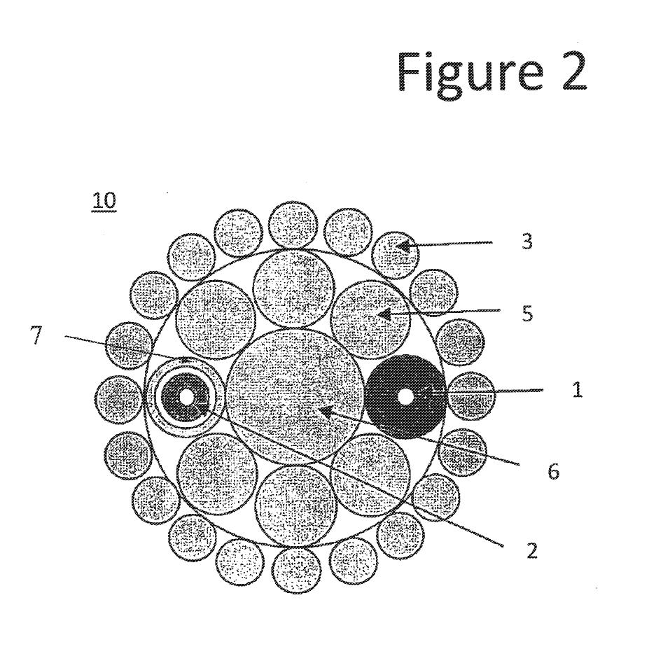

FIG. 2 shows another example of conventional cable 10. Another conventional DPTS has a 1.15˜1.20 mm diameter GIP 6 at the center of the cable and the center GIP 6 is surrounded by six (6) 1.15˜1.20 mm diameter GIP 5, a temperature measuring optical fiber 2 enclosed in a metallic tube 7 with the same diameter as the 1.15˜1.20 mm GIP and a pressure measuring optical fiber 1 with the same diameter as the 1.15˜1.20 mm GIP. In the current embodiment, the metallic tube 7 enclosing a temperature measurement optical fiber 2 does not have any strengthening member inside the metallic tube 7. The six (6) 1.15˜1.20 mm GIPs, the metallic tube 7 enclosing the pressure measuring optical fiber 2, and the temperature measurement optical fiber 1 form a concentric layer surrounding the center GIP 6. The second layer is then surrounded by twenty (20) 0.65˜0.70 mm GIPs 3.

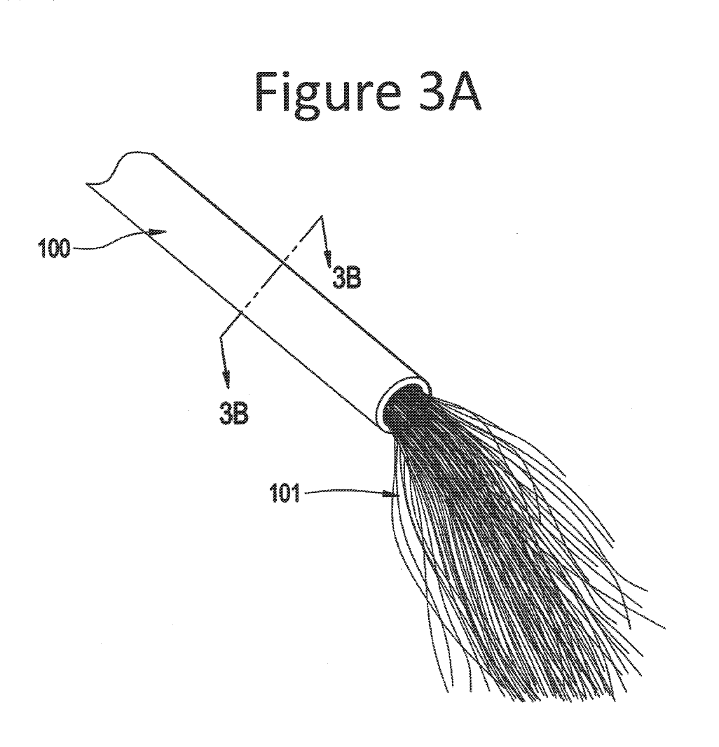

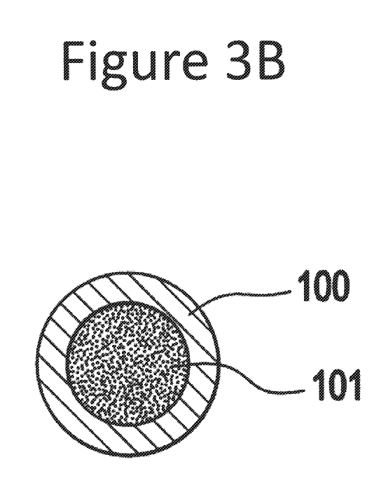

FIG. 3 shows a metallic tube with strengthening members enclosed inside. In the current embodiment, the metallic tube has a composition of stainless steel and Kevlar 5680d is used as a strengthening member. The metallic tube 7 having a thickness of 0.2 mm tube is shown. A strengthening member such as aramid yarn, PBO yarn or a carbon type yarn can be used. The strengthening members provide total strain reduction by providing light weight and lower thermal expansion coefficient.

As shown in FIG. 3A, the strengthening member 101 is a tightly bundled yarn with a diameter close to the inner diameter of the metallic tube. The strengthening member 101 fills up an entire area of the inner tube and is tightly compacted inside to provide support strength.

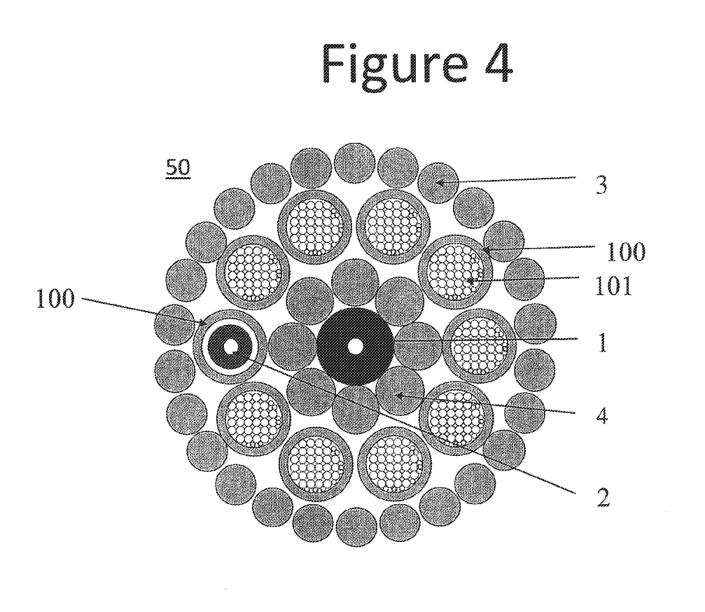

FIG. 4 shows a first embodiment of a sensor cable for long downhole 50. Instead of nine (9) of 1.15˜1.20 mm GIP wires formed as a second layer 5 as shown in FIG. 1, nine (9) of metallic tube 100 enclosing a strengthening member 101 are installed into the cable 50. In the current embodiment shown, an aramid yarn is included in an SST as a metallic tube having 1.15˜1.20 mm outer diameter (OD)/0.9˜0.95 mm inner diameter (ID). Each Aramid yarn is protected by SST having 1.15˜1.20 mm OD in order to prevent any damage from the harsh environment (i.e. high temperature water including NaCl, KCl, CO2, H2S or heavy metals). Other components are exactly same as what is shown in FIG. 1.

As a preferred embodiment shown in FIG. 4, 5860d of Kevlar from Toray is used as the aramid yarn. However, other materials such as PBO yarn (e.g. Zylon from Toyobo) or Polyacrylonitarile carbon fiber (Trayca from Toray) can also be enclosed in the metallic tube 100.

The strengthening members such as aramid yarn have a feature of light weight. Therefore, compared to the conventional cable shown in FIGS. 1 and 2, the cable weight is reduced to 131.3 kg/km and the cable strain down to 0.182%. This is approximately 23% reduction in weight per length and 7% reduction in cable strain, respectively.

Aramid yarn also has very low coefficient of thermal expansion (CTE) compared to conventional GIP wires used in FIGS. 1 and 2. Therefore, instead of 0.184% cable strain as shown in FIG. 1, 0.161% of cable strain will be applied at 180° C. This produces approximately 12% reduction in cable strain.

Table 1 shows the calculation results of the strain and cable weight in each structure shown in FIG. 4 compared to the conventional GIP wires used in FIG. 1.

TABLE 1

| | Conventional | Aramid | PBO | Carbon |
|---|---|---|---|---|
| | Wire (FIG. 1) | yarn | yarn | yarn |
| Weight per | 171.5 | 131.6 | 130.9 | 131.3 |
| length (kg/km) | | | | |
| Strain at 5 km | 0.196 | 0.182 | 0.166 | 0.151 |
| installation (%) | | | | |
| Strain at 180° C. (%) | 0.184 | 0.161 | 0.146 | 0.133 |
| Total Strain (%) | 0.380 | 0.343 | 0.312 | 0.284 |

As an example of aramid yarn type in Table 1, Kevlar 49 is used with an SST. As a result, 23.3% of the weight reduction and 9.7% of the total strain (thermal strain plus tensile strain) reduction comparing with the conventional wire structure are possible. As an example of PBO yarn type in this table, Zylon (High modulus type) is used with an SST. As a result, 23.7% of the weight reduction and 17.9% of the total strain reduction comparing with the conventional wire structure are possible. As an example of Carbon type in this table, Trayca M35 is used with an SST. As a result, 23.4% of the weight reduction and 25.3% of the total strain reduction comparing with the conventional wire structure are possible.

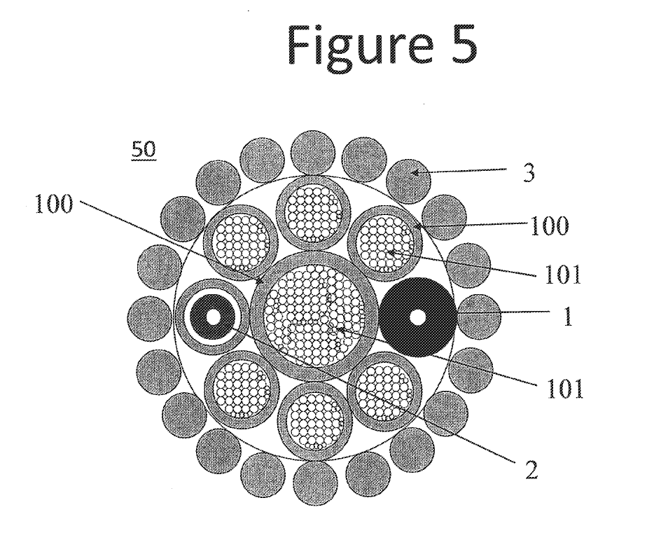

FIG. 5 shows a second embodiment of a sensor cable for long downhole 50. In this example, a center 2.0 mm GIP 6 in FIG. 2 has been replaced with 11360d of Kevlar in a metallic tube 100 having an approximately 2.0 mm OD/1.6 mm ID. Further, 1.15˜1.2 mm GIP wires 5 in FIG. 2 are replaced by a strengthening member 101 enclosed within a 1.15˜1.2 mm outer diameter of a metallic tube 100. In the current embodiment, 5860d of Kevlar is in SST having 1.15˜1.2 mm OD/0.9˜0.95 mm ID. As a result, the cable weight was reduced from 140.6 kg/km to 99.3 kg/km which results in 29% reduction. Similarly, cable strain will be reduced as shown in Table 2.

Table 2 shows the calculation results of the strain and cable weight of the sensor cable for long downhole 50 in comparison with a conventional wire shown in FIG. 2.

TABLE 2

| | Conventional | Aramid | PBO | Carbon |
|---|---|---|---|---|
| | Wire (FIG. 2) | yarn | yarn | yarn |
| Weight per length | 140.6 | 99.3 | 99.3 | 100.6 |
| (kg/km) | | | | |
| Strain at 5 km | 0.202 | 0.189 | 0.169 | 0.146 |
| installation (%) | | | | |
| Strain at 180° C. (%) | 0.184 | 0.157 | 0.141 | 0.120 |
| Total Strain (%) | 0.386 | 0.346 | 0.310 | 0.266 |

As an example of Aramid yarn type of the strengthening member 101 in Table 2, Kevlar 49 is used with an SST. As a result, 29.4% of the weight reduction and 10.4% of the total strain reduction comparing with the conventional wire structure are possible. As an example of PBO yarn type, Zylon (High modulus type) is used with a SST. As a result, 29.4% of the weight reduction and 19.7% of the total strain reduction comparing with the conventional wire structure are possible. As a Carbon type, Trayca M35 is used with a SST. As a result, 28.5% of the weight reduction and 31.1% of the total strain reduction comparing with the conventional wire structure are possible.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A sensing cable comprising:
an armored layer comprising a plurality of annular wires;
wherein at least one of said plurality of annular wires comprises of a metallic tube and a strengthening member.

2. The sensing cable in claim 1,
wherein said metallic tube comprises stainless steel.

3. The sensing cable in claim 1,
wherein an optical fiber is arranged inside one of said annular wires of said armored layer.

4. The sensing cable in claim 1,
wherein an optical fiber surrounded by a wire armor is surrounded by said armored layer.

5. The sensing cable in claim 4,
wherein said wire armor comprises of a plurality of galvanized improved plow wires.

6. The sensing cable in claim 1,
wherein said armored layer is surrounded by a plurality of metallic wire.

7. The sensing cable in claim 1,
wherein said strengthening member is an aramid yarn.

8. The sensing cable in claim 1,
wherein said strengthening member is a PBO yarn.

9. The sensing cable in claim 1,
wherein said strengthening member is a Polyacrylonitarile carbon fiber.

10. A sensing cable comprising:
a center annular wire;
an armored layer comprising a plurality of annular wires;
wherein said center annular wire and said plurality of annular wires comprise a metallic tube and a strengthening member.

11. The sensing cable in claim 10,
wherein said metallic tube comprises of stainless steel.

12. The sensing cable in claim 10,
wherein an optical fiber forms a substantially concentric circle along with said armored layer.

13. The sensing cable in claim 10,
wherein an optical fiber is arranged inside of said annular wire.

14. The sensing cable in claim 10,
wherein said armored layer is surrounded by plurality of metallic wire.

15. The sensing cable in claim 10,
wherein said strengthening member is an aramid yarn.

16. The sensing cable in claim 10,
wherein said strengthening member is a PBO yarn.

17. The sensing cable in claim 10,
wherein said strengthening member is a Polyacrylonitarile carbon fiber.
